(19) United States
(12) Patent Application Publication
(10) Pub. No.: US 2011/0070049 A1
(43) Pub. Date: Mar. 24, 2011

(54) FASTENER

(76) Inventor: KUO-CHUNG WANG, YUNLIN COUNTY (TW)

(21) Appl. No.: 12/566,393

(22) Filed: Sep. 24, 2009

(51) Int. Cl. F16B 37/14

(52) U.S. Cl. 411/372.6

(57) ABSTRACT

A fastener includes a barrel for fastening to a mounting through hole of a first metal plate member, a screw member inserted through the barrel for threading into a screw hole of a second metal plate member to joint the first and second metal plate members together, a cap molded on the screw member for holding the barrel temporarily on the inside by means of friction engagement between the barrel and the cap, a spring member sleeved onto the screw member and stopped between the shoulder of the screw member and an inside annular flange of the barrel, and a C-shaped retainer ring fastened to the shank of the screw member to prohibit falling of the screw member out of the barrel.

### BACKGROUND OF THE INVENTION

1. Field of the Invention

The present invention relates to a fastener for joining two metal plate members and more particularly, to such a fastener, which enables the barrel to be temporarily secured to the inside of the cap by means of friction engagement, facilitating installation.

2. Description of the Related Art

When fastening plate members together, a positioning screw formed of a knob, a ring and a screw nail is usually used. During installation, the screw nail and the ring are secured to the first plate member, and then the knob is rotated to drive the screw nail into the second plate member, and then a hand tool is used to fasten tight the screw nail, affixing the first and second plate members together. This plate member joining method can be used in a machine tool to join plate members together.

There is known a fastener comprised of a cap, a screw member, a spring member and a barrel for joining two metal plate members together. The spring member is sleeved onto the screw, and then the barrel is attached to the cap. During installation, the barrel is affixed to a mounting through hole on a first metal plate member, and then the screw member is driven into a screw hole on a second metal plate member to join the two metal plate members together. Further, after unfastened the screw member from the screw hole of the second metal plate member and removal of the first metal plate member from the second metal plate member, the fastener is kept secured to the first metal plate member.

FIG. 8 is a schematic sectional side view, showing an installation status of a fastener according to the prior art design. As illustrated, the fastener comprises a cap A, a screw member B mounted in the cap A, a barrel D slidably coupled to the cap A and surrounding the screw member B, and a spring member C sleeved onto the screw member B and stopped between a part inside the cap A and a part inside the barrel D. During installation, pick up the cap A of the fastener manually, and then insert the barrel D into a mounting through hole E1 on one metal plate member E, and then solder the bonding flange D1 of the barrel D to the top wall of the metal plate member E around the mounting through hole E1 with a solder paste E2. Thus, the fastener is secured to the metal plate member E. However, this manual installation procedure wastes much labor and time, resulting in low work efficiency. To improve work efficiency, an automatic machine may be used and operated to pick up the cap A of the fastener and to insert the barrel D into the mounting through hole E1 of the metal plate member E. Further, in order to avoid vibration of the barrel D relative to the cap A and the screw member B during installation, a Teflon ring F may be squeezed into the barrel D and forced into friction engagement with the screw member B. After the barrel D is locked to the screw member B by the Teflon ring F, the barrel D can be bonded to the top wall of the metal plate member E around the mounting through hole E1 with the solder paste E2 accurately. After bonding of the barrel D to the metal plate member E, the cap A is operated to rotate the screw member B and to force the Teflon ring F away from the barrel D. Using the Teflon ring F to temporarily lock the barrel D to the screw member B complicates the installation procedure. Further, when squeezing the Teflon ring F into the barrel D, the Teflon ring F may be deformed and the barrel D may be biased relative to the screw member B, affecting installation accuracy.

Therefore, it is desirable to provide a fastener for joining metal plate members that eliminates the aforesaid problems.

### SUMMARY OF THE INVENTION

The present invention has been accomplished under the circumstances in view. It is therefore an object of the present invention to provide a fastener for joining metal plate members, which facilitates installation and presents the spring member from falling out of the barrel during installation. It is another object of the present invention to provide a fastener for joining metal plate members, which facilitates quick installation by an automatic installation machine without any secondary installation procedure, saving much installation time and labor.

To achieve these and other objects of the present invention, a fastener comprises a barrel for fastening to a mounting through hole of a first metal plate member, a screw member inserted through the barrel for threading into a screw hole of a second metal plate member to joint the first and second metal plate members together, a cap molded from plastics or rubber on the screw member for holding the barrel temporarily on the inside by means of friction engagement between the barrel and the cap, a spring member sleeved onto the screw member and stopped between the shoulder of the screw member and an inside annular flange of the barrel, and a C-shaped retainer ring fastened to the shank of the screw member to prohibit falling of the screw member out of the barrel. By means of friction engagement between the cap and the barrel, the barrel is temporarily secured to the inside of the cap, enabling the barrel to be quickly installed in the mounting through hole of the first metal plate member by an automatic machine by means of a reflow soldering process. After bonding of the barrel to the first metal plate member, the cap can be rotated to release the barrel, for enabling the screw member to be driven into the corresponding screw hole on the second metal plate member to affix the first metal plate member and the second metal plate member together.

### BRIEF DESCRIPTION OF THE DRAWINGS

FIG. 1 is an elevational view of a fastener in accordance with the present invention.

FIG. 2 is an exploded view of the fastener in accordance with the present invention.

FIG. 3 is an exploded view, partially in sectional elevation, of the fastener in accordance with the present invention.

FIG. 4 is a sectional side view of the present invention, showing the cap, the screw member, the spring member ad the barrel assembled before mounting of the C-shaped retainer ring.

FIG. 5 is a sectional side view of the present invention, showing the fastener assembled.

FIG. 6 is a schematic sectional view of the present invention, showing the barrel of the fastener bonded to a metal plate member before attachment of the first metal plate member to a second metal plate member.

FIG. 7 corresponds to FIG. 6, showing the first metal plate member attached to the second metal plate member and the screw member threaded into the corresponding screw hole of the second metal plate member.

FIG. 8 is a schematic sectional side view, showing an installation status of a fastener according to the prior art design.

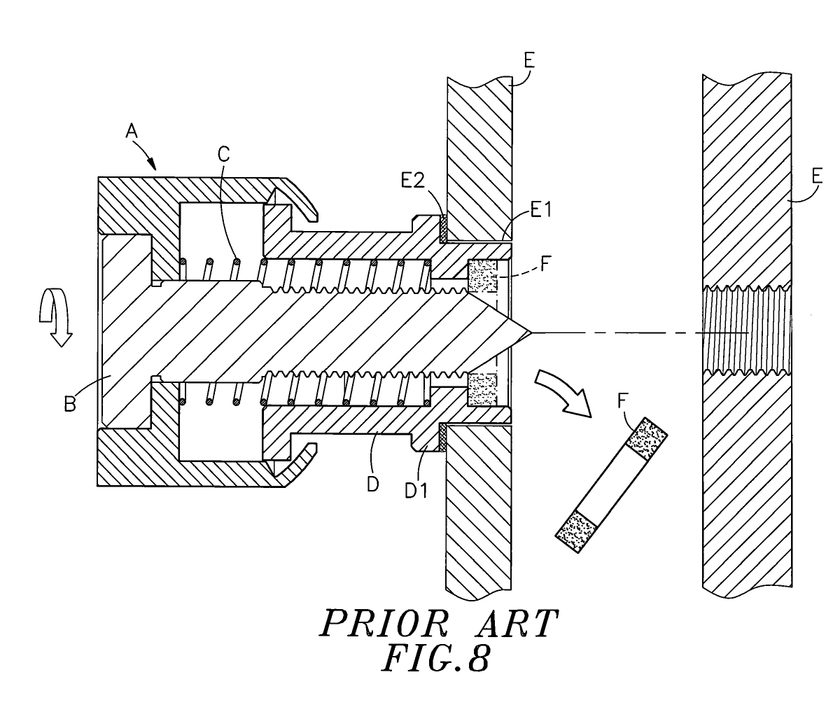

### DETAILED DESCRIPTION OF THE PREFERRED EMBODIMENT

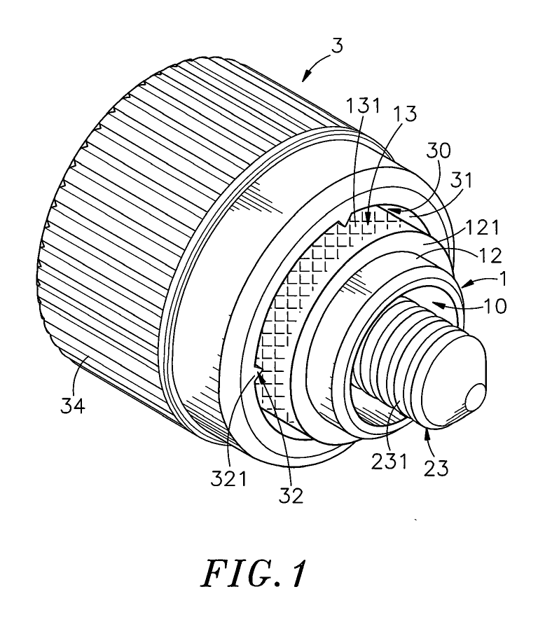

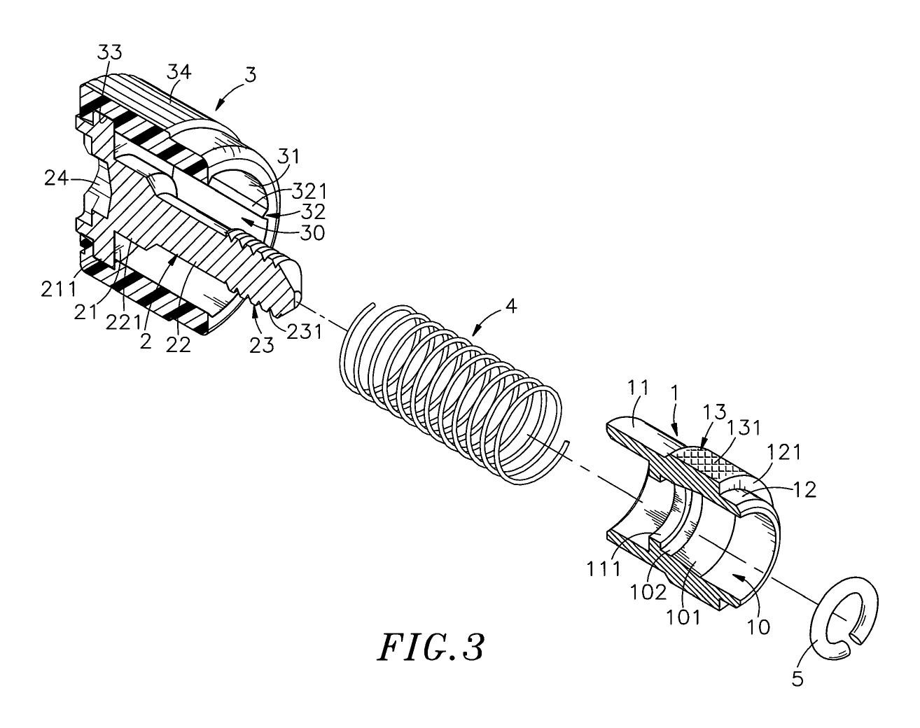

Referring to FIGS. 1-3, a fastener in accordance with the present invention is shown comprising a barrel 1, a screw member 2, a cap 3, a spring member 4 and a C-shaped retainer ring 5.

The barrel 1 is a metal member having a tubular body 11, an inside accommodation space 10 defined in and cut through top and bottom sides of the tubular body 11 for accommodating the screw member 2 and the spring member 4, an inside annular flange 111 protruded from the inside wall of the tubular body 11 and suspending in the inside accommodation space 10, a bottom extension tube 12 axially forwardly extended from the bottom side of the tubular body 11, a friction flange 13 extending around the periphery of the tubular body 11 adjacent to the bottom extension tube 12, and a bonding face 121 defined between the bottom extension tube 12 and the friction flange 13.

The screw member 2 is a metal member having a head 21, an engagement portion 211 formed on the periphery of the head 21, a plain shank 22 perpendicularly extended from the center of the bottom wall of the head 21, a threaded shank 23 axially extended from one end of the plain shank 22 opposite to the head 21 and carrying a thread 231 around the periphery, a shoulder 221 connected between the bottom wall of the head 21 and the plain shank 22, and a tool groove 24 located on the top wall of the head 21. Further, the tool groove 24 can be a Phillipes groove, keystone groove, asterisk groove or hex groove.

The cap 3 is a hollow member having a center opening 30 axially extending through the top and bottom sides for receiving the barrel 1, the screw member 2 and the spring member 4, friction means 32, for example, friction ribs 321 protruded from the inside wall within the center opening 30 and extended to the front open side 31 of the center opening 30 for friction with the friction flange 13, an inside retaining groove 33 extending around the inside wall within the center opening 30 near the top side for retaining the engagement portion 211 of the screw member 2, and a grip 34 located on the periphery at the top side for gripping by hand.

The spring member 4 is sleeved onto the plain shank 22 and threaded shank 23 of the screw member 2 and stopped the between inside annular flange 111 of the barrel 1 and the shoulder 221 of the screw member 2.

The C-shaped retainer ring 5 is mounted in the inside accommodation space 10 of the barrel 1 and retained to the plain shank 22 and stopped between the inside annular flange 111 of the barrel 1 and the thread 231 of the threaded shank 23 of the screw member 2 to prohibit the screw member 2 from falling out of the barrel 1.

Further, the screw member 2 is a metal member. The cap 3 can be molded from a plastic or rubber material on the head 21 of the screw member 2 by over molding. Alternatively, the cap 3 can be fastened to the head 21 of the screw member 2 by means of any of a variety of joints or by a bonding technique to have the engagement portion 211 of the screw member 2 be fixedly secured to the inside retaining groove 33 of the cap 3. Thus, by means of manipulate the grip 34, the user can rotate the screw member 2 with less effort. Further, the engagement portion 211 can be formed of barbs, teeth or conical protrusions.

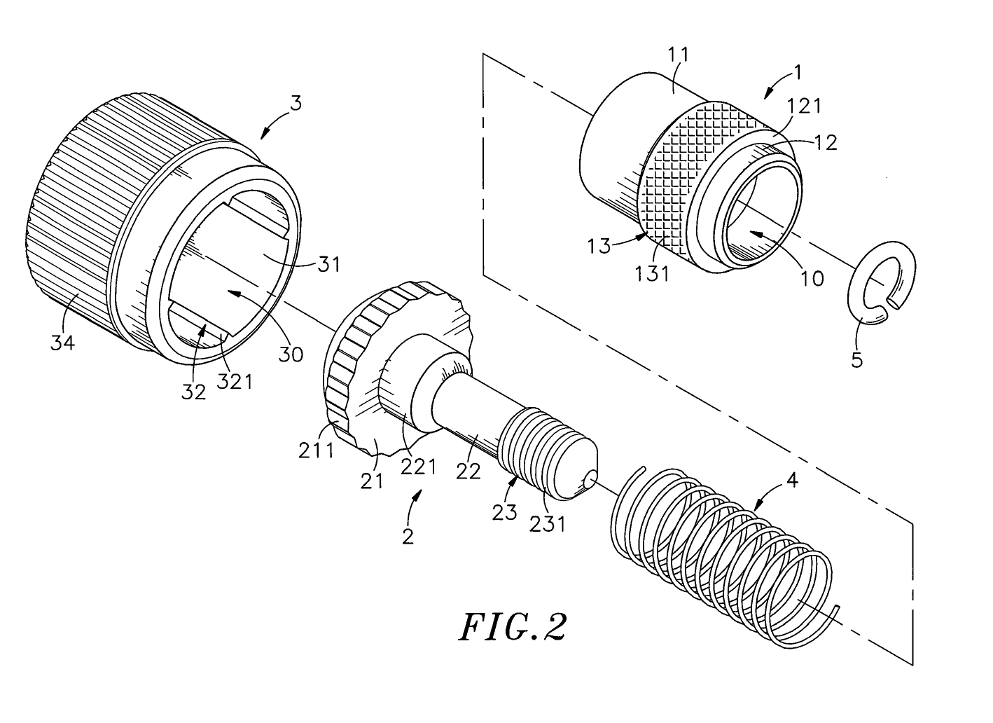

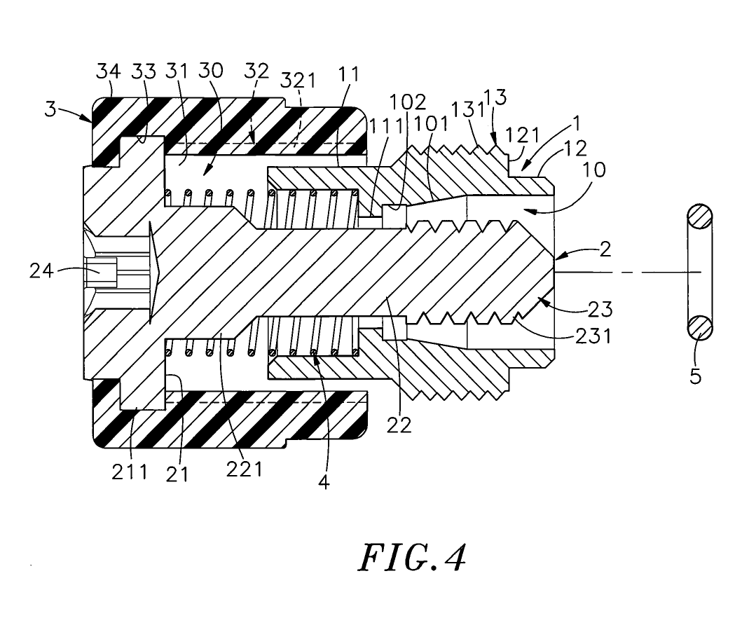

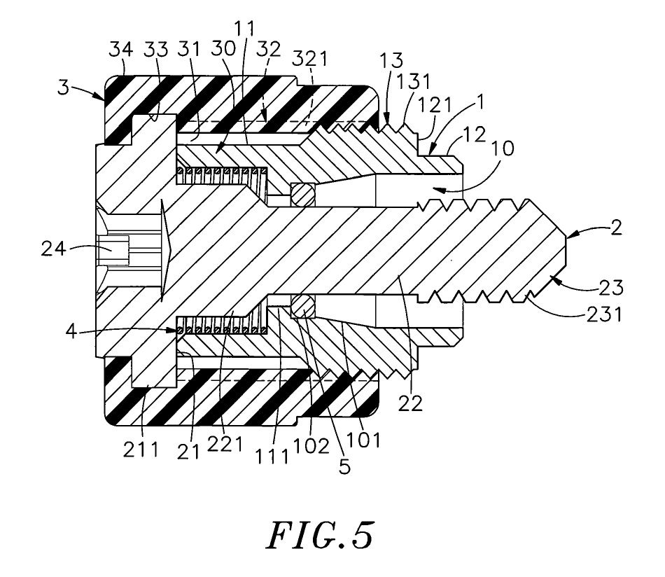

Referring to FIGS. 4 and 5 and FIGS. 2 and 3 again, after molding of the cap 3 on the head 21 of the screw member 2 or fixation of the cap 3 to the head 21 of the screw member 2, the spring member 4 is sleeved onto the plain shank 22 and threaded shank 23 of the screw member 2 and stopped with its one end against the shoulder 221 of the screw member 2, and then the barrel 1 is inserted into the center opening 30 of the cap 3 to stop the inside annular flange 111 against the other end of the spring member 4 and to force the friction flange 13 into friction engagement with the friction ribs 321 in the center opening 30 of the cap 3. Thus, the barrel 1 is temporarily secured to the cap 3. At this time, the threaded shank 23 of the screw member 2 suspends outside the barrel 1. Thereafter, a crimping tool or the like (not shown) is used to attach the C-shaped retainer ring 5 to the screw member 2, forcing the C-shaped retainer ring 5 along a tapered inside surface portion 101 into a positioning groove 102 in the inside accommodation space 10 of the barrel 1 so that the C-shaped retainer ring 5 is stopped at the inside annular flange 111 of the barrel 1 and retained to the thread 231 of the threaded shank 23 of the screw member 2 to prohibit the screw member 2 from falling out of the barrel 1.

Further, when pressing the cap 3 onto the barrel 1, the friction ribs 321 of the friction means 32 of the plastic or rubber cap 3 will be forced into friction engagement with the coarsened surface 131 of the friction flange 13 to hold the barrel 1 in the cap 3 temporarily. The coarsened surface 131 can be an embossed surface having densely distributed raised portions or protrusions. Further, a number of barrels 1 can be joined by a material strip during their fabrication. This fabrication method facilitates product pickup, simplifies the manufacturing process, increases the yield rate and lowers the manufacturing cost. Further, a linked series of barrels can easily and rapidly be installed in one first metal plate member, and the follow-up installation of the respective caps is also easy.

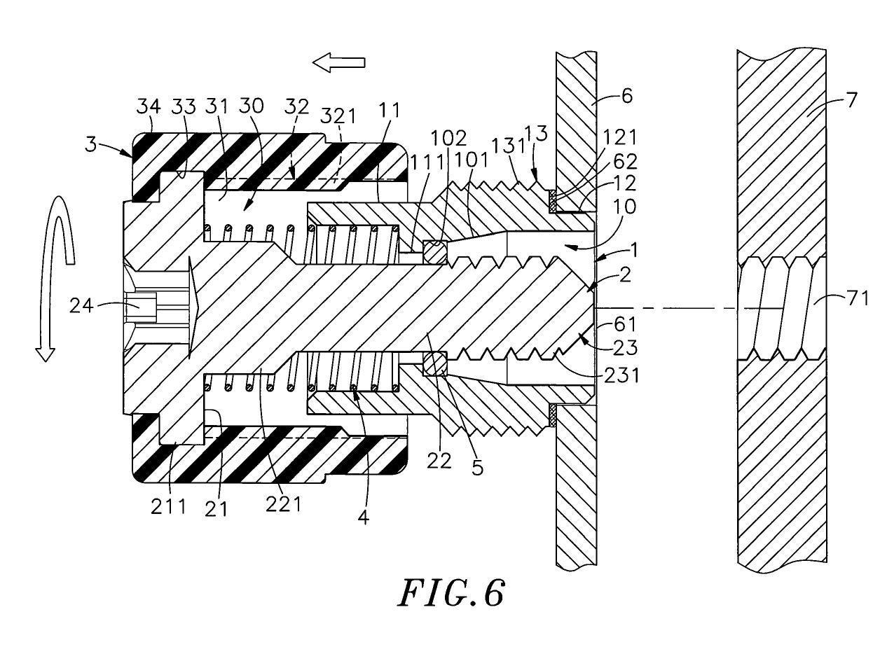

Referring to FIG. 6, during installation, an automatic pickup machine is used to catch the cap 3 of the fastener and to move the fastener in axial alignment with one mounting through hole 61 on a first metal plate member 6, and then to insert the bottom extension tube 12 of the barrel 1 of the fastener into the mounting through hole 61 of the first metal plate member 6 and to have the bonding face 121 of the barrel 1 be attached to the solder paste 52 been applied to the border area of the mounting through hole 61 of the first metal plate member 6, and then a reflow soldering process is applied to have the barrel 1 be bonded to the first metal plate 6.

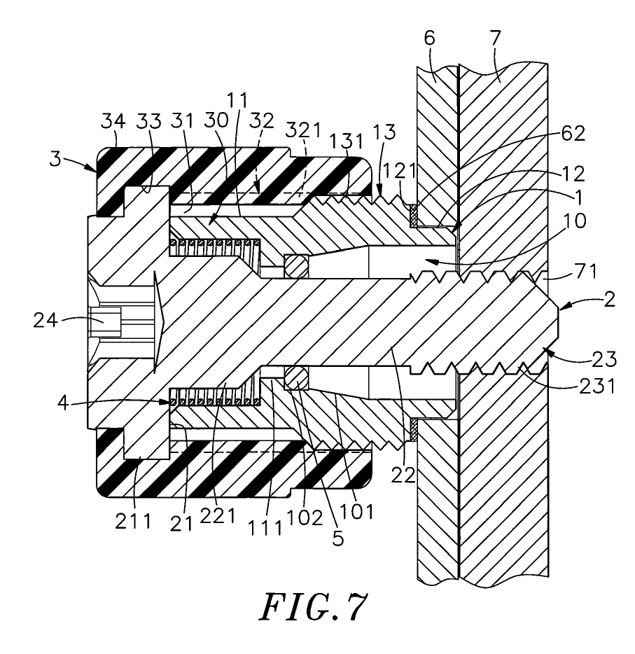

Referring to FIG. 7 and FIGS. 2, 3 and 6 again, after installation of the barrel 1 in the first metal plate member 6, rotate the grip 34 of the cap 3 to move the friction means 32 of the plastic or rubber cap 3 away from the coarsened surface 131 of the friction flange 13 to hold the barrel 1 for enabling the spring member 4 to push the barrel 1 out of the cap 3. At this time, the screw member 2 is moved axially with the cap 3 relative to the barrel 1 and received inside the barrel 1. By means of the positioning of the C-shaped retainer ring 5 on the periphery of the plain shank 22 of the screw member 2 between the inside annular flange 111 of the barrel 1 and the thread 231 of the threaded shank 23 of the screw member 2, the screw member 2 is prohibited from falling out of the barrel 1. The first metal plate member 6 can then be attached to a second metal plate member 7 to keep the mounting through hole 61 of the first metal plate member 6 in alignment with a corresponding screw hole 71 on the second metal plate member 7. Thereafter, force the cap 3 downwards and rotate the cap 3 to drive the outer thread 231 of the screw member 2 into the screw hole 71 of the second metal plate member 7, and then attach a hand tool (for example, screwdriver) to the tool groove 24 of the screw member 2 and rotate the hand tool to tighten up the connection between the screw member 2 and the second metal plate member 7. Thus, the first metal plate member 6 and the second metal plate member 7 are firmly secured together by the fastener.

It is to be understood that For example, the barrel 1 can be made of aluminum, brass, zinc alloy or any other metal material; the coarsened surface 131 of the friction flange 13 around the periphery of the tubular body 11 of the barrel 1 can be formed by means of an extrusion, embossing or milling technique; the cap 3 can be molded from a plastic or rubber material; instead of the design of friction ribs 321, the friction means 32 of the cap 3 can be an embossed surface or a number of teeth or conical protrusions for friction engagement with the coarsened surface 131 of the barrel 1 to temporarily secure the barrel 1 to the inside of the cap 3 and to facilitate installation of the barrel 1 of the fastener in the mounting through hole 61 of the first metal plate member 6 by an automatic machine by means of a reflow soldering process. After installation of the barrel 1 of the fastener in the mounting through hole 61 of the first metal plate member 6, the operator can rotate the grip 34 of the cap 3 to disengage the friction means 32 of the cap 3 from the coarsened surface 131 of the barrel 1 for enabling the first metal plate member 6 to be attached to the second metal plate member 7 and locked thereto by the fastener. Thus, the invention eliminates a secondary installation procedure to mount the cap on the barrel after bonding of the barrel to the first metal plate member as employed according to the prior art design. Therefore, the invention greatly saves much installation labor and installation time.

A prototype of fastener for fastening metal plate members has been constructed with the features of FIGS. 1-7. The fastener functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A fastener for fastening to a mounting through hole of a first metal plate member and a screw hole of a second metal plate member to join said first metal plate member and said second metal plate member together, the fastener comprising:
a barrel, said barrel having a tubular body, an inside accommodation space extending through top and bottom sides of said tubular body thereof, an inside annular flange protruded from an inside wall of said tubular body and suspending in said inside accommodation space, a bottom extension tube axially forwardly extended from the bottom side of said tubular body for insertion into said mounting through hole of said first metal plate member, and a friction flange extending around the periphery of said tubular body adjacent to said bottom extension tube;
a screw member, said screw member having a head, a shank perpendicularly extended from a bottom wall of said head and insertable through the mounting through hole of said first metal plate member, a thread spirally extending around the periphery of a distal end of said shank far from said head for threading into the screw hole of said second metal plate member and a shoulder connected between said head and said shank;
a cap fixedly fastened to the head of said screw member, said cap having a center opening axially extending through top and bottom sides thereof for receiving said barrel and said screw member, friction means formed on an inside wall thereof for friction engagement with the friction flange of said barrel to secure said barrel to the inside of said cap; and
a spring member sleeved onto the shank of said screw member and stopped between said shoulder of said screw member and said inside annular flange of said barrel.

2. The fastener as claimed in claim 1, wherein the friction flange of said barrel has a part thereof machine processed to form a coarsened surface for friction engagement with the friction means of said cap; said friction means comprises at least one of the group of embossed surface, teeth and conical protrusions for friction engagement with the coarsened surface of said barrel; said cap has a grip formed integral with the periphery thereof for manipulation by hand.

3. The fastener as claimed in claim 2, wherein said coarsened surface of said barrel comprises an embossed surface having densely distributed protrusions.

4. The fastener as claimed in claim 1, wherein said barrel is made of a metal material selected from a group of aluminum, brass and zinc alloy.

5. The fastener as claimed in claim 1, wherein said cap is made of a flexible material selected from a group of plastics and rubber.

6. The fastener as claimed in claim 1, wherein said screw member has a C-shaped retainer ring mounted on the periphery thereof and stopped between said thread and one side of said inside annular flange of said barrel opposite to said spring member; said screw member has a tool groove located a top wall of said head opposite to said shank.

7. The fastener as claimed in claim 1, wherein said barrel has a bonding face defined between said bottom extension tube and said friction flange for stopping against a solder paste on said first metal plate member around said mounting through hole for enabling said barrel to be bonded to said first metal plate member through a reflow soldering process.

8. The fastener as claimed in claim 1, wherein said screw member has an engagement portion formed on the periphery of said head; said cap has an inside retaining groove extending around the inside wall thereof within said center opening near the top side thereof for retaining the engagement portion of said screw member.
